(19) United States
(12) Patent Application Publication
(10) Pub. No.: US 2005/0252895 A1
(43) Pub. Date: Nov. 17, 2005

(54) Sensor device for detecting radiation from the region of a zone of interaction between a laser beam and a workpiece and device for monitoring a laser machining operation and laser machining head

(75) Inventors: Bert Schuermann, Gernsbach (DE); Berthold Kessler, Greifenstein Arborn (DE); Jorg Bernges, Gaggenau (DE)

Correspondence Address: BIRCH STEWART KOLASCH & BIRCH, PO BOX 747, FALLS CHURCH, VA, 22040-0747, US

(73) Assignee: Precitec KG, Gaggenau-Bad Rotenfels (DE)

(21) Appl. No.: 11/115,244

(22) Filed: Apr. 27, 2005

(30) Foreign Application Priority Data
Apr. 28, 2004 (DE) 10 2004 020 704.6

(51) Int. Cl. B23K 26/03; B23K 26/20

(52) U.S. Cl. 219/121.83; 219/121.63

(57) ABSTRACT

The invention relates to a sensor device for detecting radiation from the region of a zone of interaction (16) between a laser beam and a workpiece (17) for monitoring a laser machining operation and a workpiece, in particular a laser welding operation, and a device for monitoring the laser machining operation, in particular the laser welding operation, and a laser machining head having such a sensor device. The sensor device possesses a radiation-sensitive receiver arrangement and an imaging device which images a region to be observed in the region of a zone of interaction (16) onto the receiver arrangement. In order to achieve a compact and space-saving structure it is provided that the imaging device comprises a focusing mirror arranged in the working beam pathway of the laser beam which diverts radiation from the region to be observed out of the working beam pathway and focuses it onto the receiver arrangement.

The invention relates to a sensor device for detecting radiation from the region of a zone of interaction between a laser beam and a workpiece for monitoring a laser machining operation, in particular a laser welding operation, and a device for monitoring the laser machining operation, in particular a laser welding operation, and a laser machining head having such a sensor device and monitoring device.

For process monitoring in laser machining, in particular in laser-beam welding, that is in the monitoring of laser machining operations, sensor devices and monitoring devices are employed which for radiation-sensitive receivers make use of photodiodes or CCD image sensors which detect and record optical emissions during the machining process.

For this purpose external systems inter alia are employed which use sensors built onto the outside of a laser machining head, for example planar cameras, that is to say CCD image sensors having receiver elements arranged over an area, or linear cameras, that is to say CCD image sensors having receiver elements arranged in linear fashion, or photodiode systems. Separate imaging optics and protective devices are assigned to these sensors.

DE 100 13 892 A1 discloses such an external device for determining the welding quality on a welded joint between workpieces. The device comprises first and second sensor fittings which are both connected to a measuring device and measure the emission intensity of light emitted laterally at various angles from the welded joint.

In addition to external systems for monitoring laser machining operations systems are also employed in which for transport of the radiation from the zone of interaction between the laser beam and workpiece to the radiation-sensitive receivers at least single elements of the laser-beam guide system are used inside the laser machining head.

DE 101 20 251 A1, for example, discloses a method and a sensor device for monitoring a laser machining operation to be carried out on a workpiece in which the process radiation from the region of interaction between the laser beam and workpiece arrives via the focusing lens for the working laser beam at a divider mirror with the aid of which the radiation coming from the zone of interaction is diverted out of the working beam pathway. An imaging optics system following the divider mirror then focuses the radiation onto a location-resolving receiver arrangement having a diaphragm for determining a field of observation on the workpiece.

DE 101 60 623 A1 relates to another device for monitoring a laser machining operation. This known sensor device and monitoring device is employed with a laser machining head in which a collimated working laser beam is diverted by a diverting mirror onto a hollow mirror serving as focusing optics. In this case the hollow mirror has an effective opening which is greater than that of the diverting mirror. Accordingly, a portion of the radiation emanating from the zone of interaction between the laser beam and workpiece and striking the hollow mirror is guided annularly past the diverting mirror and can be focused by a condensing lens arranged behind the diverting mirror onto an admission aperture of a receiver arrangement. If in doing so the distance between the aperture and condensing lens is varied the field of observation in the region of the zone of interaction is shifted correspondingly.

In addition to these sensor devices and monitoring devices which use imaging elements in the working beam pathway for beam guidance, DE 198 52 302 A1 discloses a process monitoring installation in which a focusing mirror for the working laser beam is provided with a hole through which radiation originating from the zone of interaction between the laser beam and workpiece can pass in order to be directed by an optics system arranged behind the hole onto a detector. Although in this case the detector is arranged internally no optical elements of the working laser beam pathway as such are used for beam guidance.

Proceeding from this situation it is an object of the invention to provide another sensor device having in particular a compact, space-saving structure. Another object consists in providing a device for monitoring a laser machining operation and a laser machining head which despite the sensor device have a compact and space-saving structure.

These tasks are solved by the sensor device according to claim 1, the monitoring device according to claim 11 and the laser machining head according to claim 12. Advantageous refinements and developments of the invention are described in the respective subsidiary claims.

Thus, according to the invention in a sensor device for detecting radiation from the region of a zone of interaction between a laser beam and a workpiece a radiation-sensitive receiver arrangement and an imaging device are provided which images a field to be observed from the region of a zone of interaction onto the receiver arrangement, wherein the imaging device comprises a focusing optical element arranged in the working beam pathway of the laser beam which diverts radiation from the region to be observed out of the working beam pathway and focuses it onto the receiver arrangement.

The use of an optical element which serves both to divert process radiation out of the working beam pathway of the laser beam and also to focus the latter makes it possible to provide a compact sensor device which can be integrated into a laser machining head without requiring much space.

A particularly advantageous practical refinement of the sensor device according to the invention is characterised in that the focusing optical element arranged in the working beam pathway of the laser beam is a focusing mirror, in particular a focusing annular mirror, having an open aperture for the laser beam.

In a different development of the invention it is provided that the focusing optical element arranged in the working beam pathway of the laser beam is a mirror, in particular a dichroic mirror, which either allows the laser beam to pass through while deflecting radiation from a spectral region different to that of the laser beam and focuses it onto the receiver arrangement or deflects the laser beam and allows the radiation from a spectral region different to that of the laser beam to pass through and focuses it onto the receiver arrangement.

In this case by suitable choice of the dichroic material a desired filter function can already be achieved so that additional filters can be saved.

If different parameters of a laser machining operation are to be captured, monitored and if need be recorded it is expedient for the receiver arrangement to comprise at least a first and a second radiation-sensitive receiver and the radiation diverted out of the working beam pathway is divided up by means of a beam divider mirror into different beams which are each directed onto the individual receivers.

In doing this it can be provided that the individual receivers have different spectral sensitivities.

Depending on the desired and/or required monitoring tasks the receiver arrangement can comprise as receiver a photodiode and/or a photodiode array, in particular a one-dimensional or two-dimensional CCD image sensor or alternatively a PSD (position-sensitive detector) or a CMOS receiver.

In order to fix a field of measurement or observation in the region of the zone of interaction it is advantageous for a diaphragm establishing the region to be observed to be assigned to at least one of the receivers, wherein for the diaphragm a positive or negative diaphragm can be provided.

Even in the case of relatively large focal lengths for the process radiation, that is for the radiation from the region to be observed, in order to keep the building space needed on the side of the laser machining head for the sensor device small and compact it is provided that the radiation from the region to be observed diverted out of the working beam pathway is focused by a diverting mirror onto the receiver arrangement, wherein the deflection of the radiation from the region to be observed by means of the diverting mirror amounts preferably to 90° or 180°.

Usefully a sensor device according to the invention can be provided in a device for monitoring a laser machining operation, in particular a laser welding operation, comprising an evaluation circuit to which output signals of the receiver arrangement of the sensor device are fed and which processes output signals received from the receiver arrangement and for its part supplies output signals for a control or regulating circuit which controls or regulates the laser beam and/or the laser machining operation. Although it is conceivable in principle to use the output signals of the receiver arrangement directly as status, control and/or regulating signals it is nevertheless advantageous first of all to subject the signals from the receiver arrangement to signal processing so that values or signals are obtained from them which can then be processed by succeeding circuits in accordance with the requirements on the laser machining.

A laser machining head for machining a workpiece by means of a laser beam having a housing, through which a working beam pathway for the laser beam is taken, and focusing optics for focusing the laser beam to an operational focus provided outside the housing is advantageously equipped with a sensor device according to the invention.

In doing so the sensor device can be integrated into the housing or be accommodated in a separate housing which is then mounted on the housing of the laser machining head.

Another development of a laser machining head according to the invention is characterised in that an evaluation circuit is provided to which output signals of the receiver arrangement of the sensor device are fed and which processes output signals received from the receiver arrangement and for its part supplies output signals for a control or regulating circuit which controls or regulates the laser beam and/or the laser machining operation

The invention is explained in more detail below by way of example with reference to the drawings. These show:

FIG. 1 a greatly simplified schematic illustration of a sensor device according to a first exemplified embodiment of the invention;

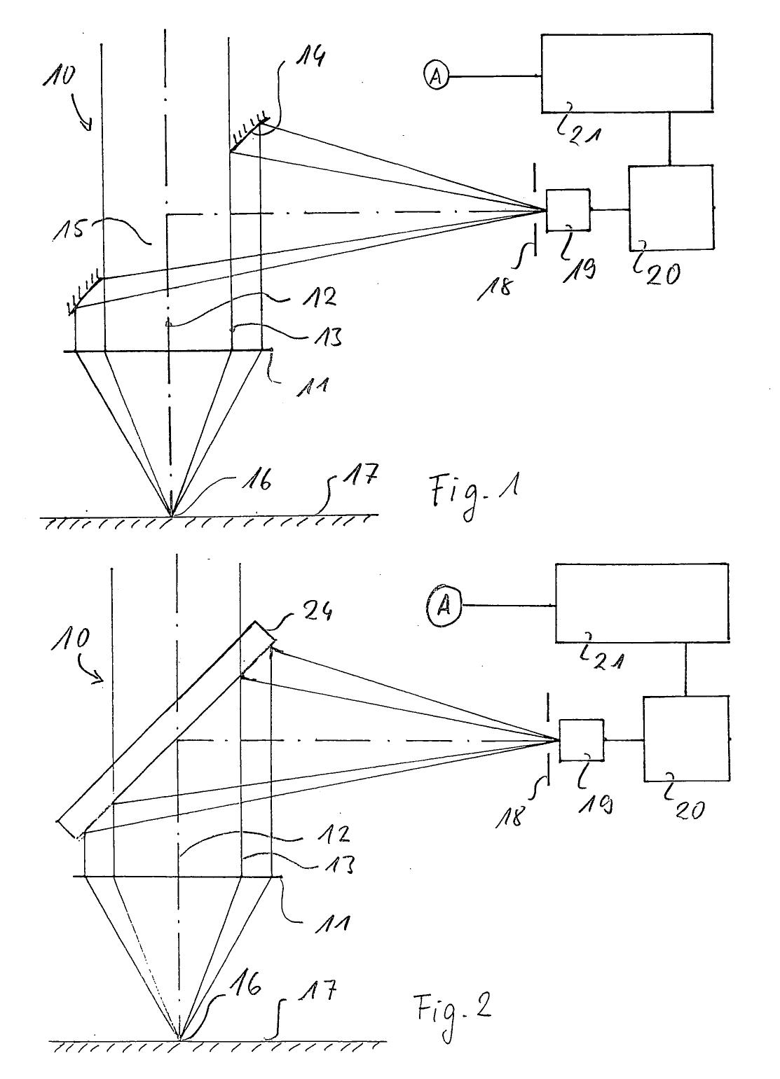

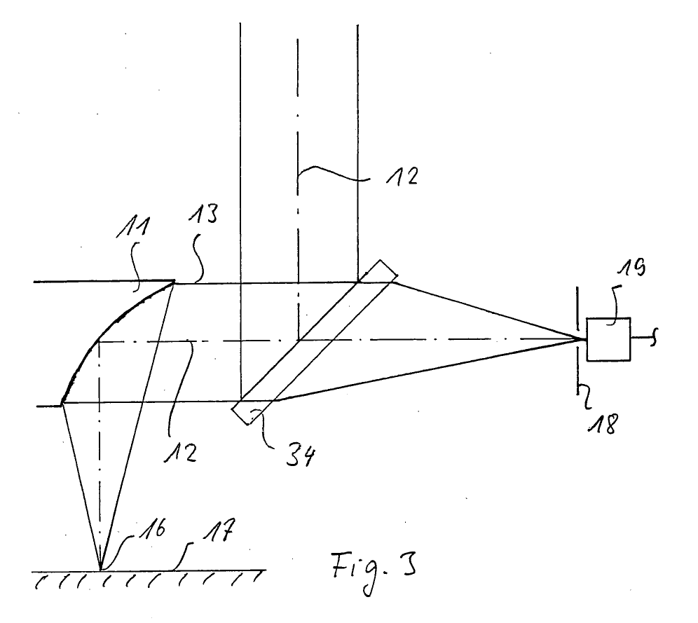

FIG. 2 a greatly simplified schematic illustration of a sensor device according to a second exemplified embodiment of the invention;

FIG. 3 a greatly simplified schematic illustration of a sensor device according to a third exemplified embodiment of the invention;

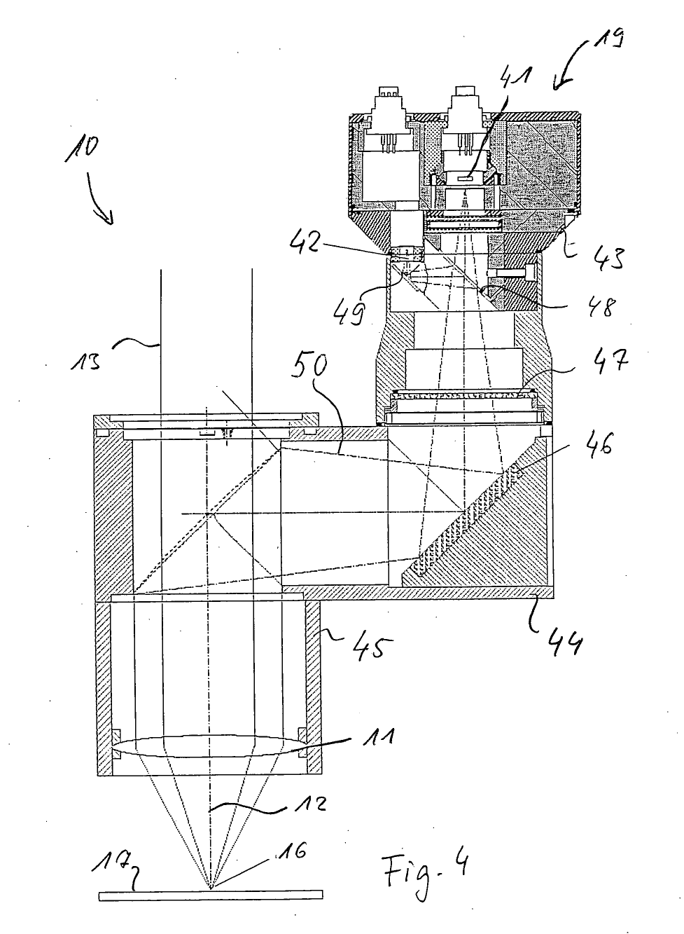

FIG. 4 an illustration in section of a laser machining head having a sensor device according to the invention;

FIG. 5 an illustration in section of a different laser machining head having a sensor device according to the present invention; and

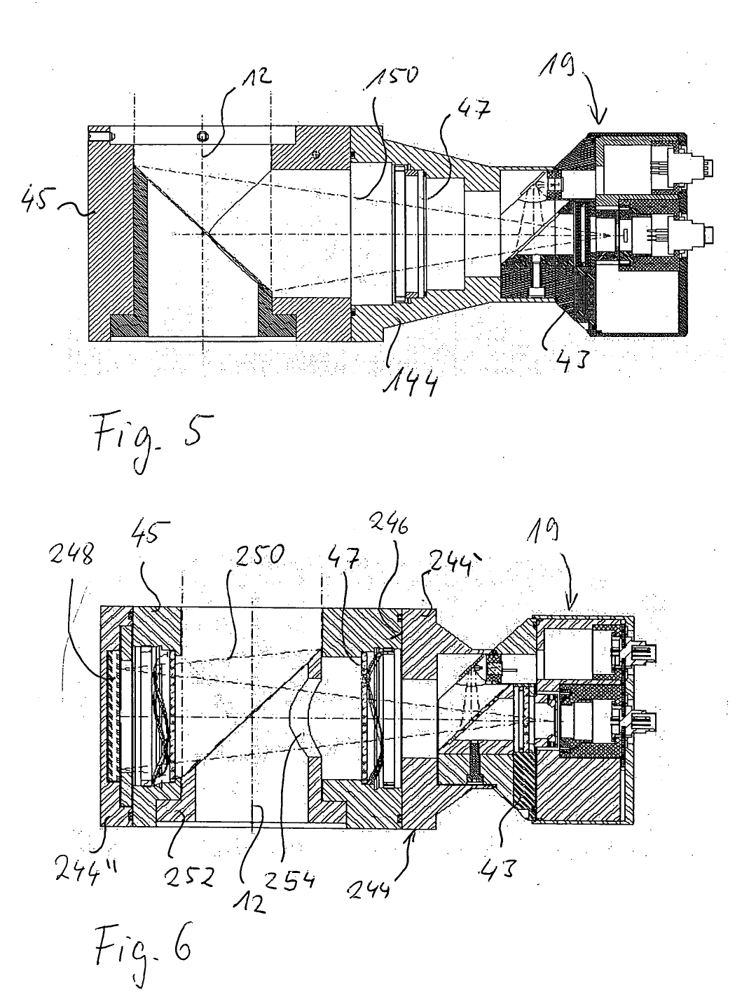

FIG. 6 an illustration in section of a further laser machining head having a sensor device according to the invention.

In the various figures in the drawings components corresponding to one another are provided with identical reference numbers.

In FIG. 1 there is a schematic illustration of a sensor device according to the invention which is integrated into a laser machining head 10 which is indicated only by a focusing optics system 11 and a working beam pathway 12 fixed by this means. The sensor device comprises an imaging device which in addition to focusing optics 11 for a laser beam 13 as focusing optical element possesses a focusing mirror 14 which according to a preferred exemplified embodiment of the invention is constructed in the form of an annular mirror having an open aperture 15 for the laser beam 13.

The imaging device formed of focusing optics 11 and the focusing annular mirror 14 in the sensor device according to the invention images a region of a zone 16 of interaction between the laser beam 13 and a workpiece 17 onto a diaphragm 18 associated with a radiation-sensitive receiver arrangement 19.

In this case the diaphragm 18 can be a positive or negative diaphragm and thus can define either a central or an annular field of observation. In a fashion not illustrated in more detail in FIG. 1 the receiver arrangement 19 can comprise one or more photodiodes having the same or differing spectral sensitivity, a camera or a one-dimensional or two-dimensional CCD image sensor. Furthermore, it is also possible to employ in the receiver arrangement 19 a position-sensitive detector, that is to say what is known as a PSD (position-sensitive detector), or a CMOS receiver, that is to say a photosensitive receiver based on CMOS technology.

The receiver arrangement 19 supplies output signals to an evaluation circuit 20 which processes the signals from the receiver arrangement 19 in order for its part to supply status signals for quality assurance and for controlling or regulating a laser machining machine. In doing so the status signals can be fed to a control or regulating circuit 21 which supplies corresponding control signals for operating a laser machining machine into whose laser machining head the sensor device according to the invention is integrated.

The evaluation circuit 20 and the control or regulating circuit 21 are illustrated in the drawing as separate functional blocks but they can also be constructed both in terms of circuitry and function as a unit. At the same time it is, for example, possible to use the output signal of the receiver arrangement 19 directly as the input signal for a control or regulating circuit.

The focusing annular mirror 14 can be constructed as a spherical or aspherical annular mirror. It is also possible, however, to use a planar annular mirror whose mirror surface is provided with a focusing diffraction pattern or a Fresnel structure.

During operation of a laser working machine, that is during a laser machining operation, a laser welding operation is in progress for example, a laser beam 13 is focused by the focusing optics 11 onto the workpiece 17 which is then melted in the region of the zone of interaction 16. The radiation emanating from the region of the zone of interaction 16 is then carried back into the working beam pathway 12 by the focusing optics 11 where it encounters the focusing annular mirror 14 which focuses an annular region of this radiation onto the diaphragm 18 of the receiver arrangement 19. Thus the imaging device of the sensor device according to the invention, that is to say the focusing optics 11 and the focusing annular mirror 14, image the zone of interaction 16 onto the diaphragm 18. Due to the relative position of the diaphragm 18 and due to its shape a certain field of observation in the region of the zone of interaction 16 can be defined.

When a negative diaphragm is used it is possible, for example, to blank out a central region of the zone of interaction 16, otherwise known as the keyhole, so that substantially only radiation from the peripheral regions of the zone of interaction 16 reaches the receiver arrangement so that reliable temperature information can be obtained.

In particular when producing linear welded joints a region located with respect to the machining direction behind the zone of interaction 16 can be imaged onto the receiver arrangement in order in this way to obtain, for example, a status signal to be used for quality assurance and/or regulation of the machining operation which indicates the success of the welding task.

If a planar or linear camera, that is a two-dimensional or one-dimensional CCD image sensor or the like, is employed for the receiver arrangement 19 temperature profiles from the region of the zone of interaction 16 can also be displayed during the laser machining operation and from these signals suitable for quality assurance and the regulation of the machining operation can then be ascertained by means of appropriate evaluation. In doing so it is conceivable, for example, that a measured temperature profile in the region of the zone of interaction be compared with a theoretically or empirically determined desired temperature profile in order then to control the laser machining operation in such a way that deviation of the measured temperature profile from the desired temperature profile is minimised.

The imaging of the zone of interaction 16 or a selected field of observation in the zone of interaction 16 or in its surrounding area onto the receiver arrangement may also be used for the geometric evaluation of the welding point for purposes of tracking the seam, measurement of the gap width and/or calculating the volume of the seam.

The exemplified embodiment of a sensor device according to the invention presented in FIG. 2 differs from the exemplified embodiment described above with reference to FIG. 1 only in that instead of a focusing annular mirror 14 a dichroic mirror 24 is provided which allows the laser beam 13 to pass through unimpeded while the process radiation originating from the region of the zone of interaction 16 is reflected by the dichroic mirror 24 and hence diverted out of the working beam pathway 12 of the laser machining head 10. In this case the dichroic mirror 24 is constructed on its side facing the focusing optics 11 in such a way that it has a focusing effect on the process radiation at least in an outlying annular region. For this purpose it can be provided, for example, with a Fresnel structure or a focusing diffraction pattern at least in the outlying annular region.

Through suitable choice of material the use of a dichroic mirror allows a certain selected spectral range of the process radiation to be selected. In doing so the choice of spectral range is made as a function of the laser machining parameters to be monitored. At the same time it is possible, for example, to detect a certain range of thermal radiation.

In the exemplified embodiment of the sensor device according to the invention shown in FIG. 3 the focusing optics 11 for the laser beam 13 is constructed as a spherical or aspherical hollow mirror while the dichroic mirror 34 is made of a material which is reflecting for the wavelength of the laser beam 13 and transmits other spectral ranges, in particular selected spectral ranges of interest in the process radiation. At the same time the reverse side of the dichroic mirror 34 is again constructed in such a way that it has a focusing effect. In doing so it is conceivable, for example, to use instead of a plate as shown in FIG. 3 a prism in which the exit surface is constructed as a focusing surface for the process radiation to be observed.

FIG. 4 shows a laser machining head 10 according to the invention having an integrated sensor device which possesses first and second receivers 41, 42 for the receiver arrangement 19. In this case the two receivers 41, 42 can be configures as photodiodes having differing spectral sensitivity, but it is also conceivable that one or both receivers are configures as cameras.

The receiver arrangement 19 is arranged in a housing 43 which is held via an angle housing 44 on a housing 45 for the laser machining head through which the working beam pathway 12 of the laser beam 13 is taken. In this case the angle housing 44 consists of a retaining section 44′ for the receiver arrangement 19 and an assembly section 44″ for attaching the laser machining head 10 to the housing 45. Here, accordingly, parts of the sensor device are accommodated in a housing arrangement 43, 44 which is mounted on the housing 45 of the laser machining head 10. In a different development of the housing for the laser machining head 10 it is also conceivable for the sensor device to be integrated with all its elements in the housing of the laser machining head.

The process radiation diverted out of the working beam pathway 12 by the focusing mirror 14, which is shown only by a dotted line in FIG. 4, is diverted towards the receiver arrangement 19 by a diverting mirror 46 arranged in the angle housing 44. In the angle housing 44 viewed in the direction of the light a protective glass 47 is arranged behind the diverting mirror 46 in order to seal off the inlet region of the receiver arrangement 19 with respect to the interior of the laser machining head 10.

A divider mirror 48 allows a portion of the process radiation to pass through to the receiver 41 while another portion is reflected and guided via another diverting mirror 49 onto the second receiver 42.

The output signals of the two receivers 41, 42, which can be constructed as photodiodes and/or as CCD image sensors, can in turn be fed for a large number of monitoring, control and regulation tasks for quality control and for process control to corresponding evaluation, control and/or regulating circuits.

Thus, in the sensor device integrated into a laser machining head 10 illustrated in FIG. 4 the sensor beam pathway 50 in the angle housing 44 is diverted by means of the diverting mirror 46 in such a way that it runs in part parallel to the working beam pathway 12. By this means the construction space on the side of the laser machining head can be kept small and compact even in the case of relatively large focal lengths.

If only relatively short focal lengths are required to focus the process radiation onto the receiver arrangement 19 or if there is sufficient construction space available on the side of the laser machining head 10 it is also possible as shown in FIG. 5 to attach the housing 43 with the receiver arrangement 19 arranged therein by means of a straight retaining element 44 directly to the housing 45 of the laser machining head 10 so that the sensor beam pathway 150 is not folded on itself.

In another development of the invention the housing 43 of the receiver arrangement 19 is arranged as shown in FIG. 6 in a retaining section 244′ of an assembly housing 244 which has a port 246 for accommodating a section of the housing 45 of the laser machining head. In a section 244″ of the assembly housing 244 diametrically opposite the retaining section 244′ a preferably planar diverting mirror 248 is provided which diverts the sensor beam pathway 250 diverted to the left out of the working laser pathway by 180° to the right towards the receiver arrangement 19.

A holder 252 which is inserted into the housing 45 of the laser machining head and carries the optical element diverting the sensor beam pathway 250 out of the working laser beam pathway is provided for this purpose with a corresponding port 254.

With the aid of this folding of the sensor beam pathway 250 a particularly small and compact structural form is achieved.

1. Sensor device for detecting radiation from the region of a zone of interaction (16) between a laser beam (13) and a workpiece (17) for monitoring a laser machining operation, in particular a laser welding operation, having
a radiation-sensitive receiver arrangement (19), and
an imaging device (11,14; 11, 24; 11, 34) which images a field to be observed from the region of a zone of interaction (16) onto the receiver arrangement (19), wherein
the imaging device (11,14; 11, 24; 11, 34) comprises a focusing optical element (14; 24; 34) arranged in the working beam pathway (12) of the laser beam which diverts radiation from the region to be observed out of the working beam pathway (12) and focuses it onto the receiver arrangement (19).

2. Sensor device according to claim 1, characterised in that the focusing optical element arranged in the working beam pathway (12) of the laser beam (13) is a focusing mirror (14), in particular a focusing annular mirror, having an open aperture (15) for the laser beam (13).

3. Sensor device according to claim 1, characterised in that the focusing optical element arranged in the working beam pathway (12) of the laser beam (13) is a mirror, in particular a dichroic mirror (24), which allows the laser beam (13) to pass through and diverts radiation from a different spectral range than that of the laser beam (13) and focuses it onto the receiver arrangement (19).

4. Sensor device according to claim 1, characterised in that the focusing optical element arranged in the working beam pathway (12) of the laser beam (13) is a mirror, in particular a dichroic mirror (34), which diverts the laser beam (13) and allows radiation from a different spectral range than that of the laser beam (13) to pass through and focuses it onto the receiver arrangement (19).

5. Sensor device according to one of the preceding claims, characterised in that the receiver arrangement (19) comprises at least a first and a second radiation-sensitive receiver (41, 42) and that the radiation diverted out of the working beam pathway (12) is divided by means of at least one beam divider mirror (48) into different beams each of which is guided onto the individual receivers (41, 42).

6. Sensor device according to claim 5, characterised in that the individual receivers (41, 42) have different spectral sensitivities.

7. Sensor device according to claim 1, characterised in that the receiver arrangement (19) comprises a photodiode as receiver.

8. Sensor device according to claim 1, characterised in that the receiver arrangement (19) comprises as receiver a photodiode array, in particular a one-dimensional or two-dimensional CCD image sensor, a PSD or a CMOS receiver.

9. Sensor device according to claim 1, characterised in that a diaphragm (18) defining the region to be observed is assigned to at least one of the receivers (41, 42).

10. Sensor device according to claim 9, characterised in that for the diaphragm (18) a positive or negative diaphragm is provided.

11. Sensor device according to claim 1, characterised in that the radiation from the region to be observed diverted out of the working beam pathway (12) is focused by a diverting mirror (46; 248) onto the receiver arrangement (19).

12. Sensor device according to claim 11, characterised in that the diversion of the radiation from the region to be observed by means of the diverting mirror (46) amounts to 90°.

13. Sensor device according to claim 11, characterised in that the diversion of the radiation from the region to be observed by means of the diverting mirror (248) amounts to 180°.

14. Device for monitoring a laser machining operation, in particular a laser welding operation, having
a sensor device according to claim 1, and
an evaluation circuit (20) to which output signals from the receiver arrangement (19) of the sensor device are fed and which processes output signals received from the receiver arrangement and for its part supplies output signals for a control or regulating circuit (21) which controls or regulates the laser beam (13) and/or the laser machining operation.

15. Laser machining head for machining a workpiece (17) by means of a laser beam (13) having:
a housing (45) through which a working beam pathway (12) for the laser beam (13) is taken;
a focusing optics system (11) for focusing the laser beam (13) to an operational focus (16) provided outside the housing (45); and having
a sensor device according to claim 1.

16. Laser machining head according to claim 15, characterised in that the sensor device is integrated in the housing.

17. Laser machining head according to claim 15, characterised in that the sensor device is accommodated in a housing (43, 44) which is mounted on the housing (45) of the laser machining head (10).

18. Laser machining head according to claim 15, 16 or 17, characterised in that an evaluation circuit (20) is provided to which output signals from the receiver arrangement (19) of the sensor device are fed and which processes output signals received from the receiver arrangement (19) and for its part supplies output signals for a control or regulating circuit (21) which controls or regulates the laser beam (13) and/or the laser machining operation.
